(19) United States
(12) Patent Application Publication
(10) Pub. No.: US 2012/0056937 A1
(43) Pub. Date: Mar. 8, 2012

(54) PRINT APPARATUS AND PRINT METHOD

(75) Inventor: Takayoshi KAGATA, Shiojiri-shi (JP)

(73) Assignee: SEIKO EPSON CORPORATION, Tokyo (JP)

(21) Appl. No.: 13/226,433

(22) Filed: Sep. 6, 2011

(30) Foreign Application Priority Data
Sep. 7, 2010 (JP) 2010-200177

(51) Int. Cl. B41J 2/21

(52) U.S. Cl. 347/43

(57) ABSTRACT

A print apparatus includes a color ink ejecting portion that ejects color ink and a metal ink ejecting portion that ejects metal ink, and prints an image using both color print data that is created based on color image data indicating a color image and specifies pixels to which the color ink is ejected and pixels to which the color ink is not ejected, and metallic print data that is created based on metallic image data indicating a metallic image and specifies pixels to which the metal ink is ejected and pixels to which the metallic ink is not ejected. When there exists an overlap portion of the color image and the metallic image, the pixels to which the color ink is ejected in the color print data and the pixels to which the metal ink is ejected in the metallic print data do not overlap each other.

### BACKGROUND

1. Technical Field

The present invention relates to print apparatuses and print methods.

2. Related Art

Print apparatuses that eject liquid through nozzles and make ink droplets (dots) land on a medium so as to perform recording are well known. Such print apparatuses use, in addition to general color ink (for example, each color ink of KCMY), metal ink that contains metal particles such as minute aluminum particles or the like as pigment in some case for printing.

It has been difficult for metallic printing with metal ink to achieve a metallic printing that shows a desirable metal gloss with a desired color hue, because balance between the metal gloss and color hue of printed material fluctuates depending on quantity of metal particles contained in the metal ink. On the other hand, print methods are proposed for printing with metal ink containing aluminum powder, in which the printing is performed in such a manner that a printed form of the metal ink becomes approximately mesh-shaped and the quantity of aluminum powder for printing is regulated by changing the size of the mesh so as to regulate the metal gloss (for example, see JP-A-11-78204).

With such print method, it is possible to print an image with high image quality and with a desirable metal gloss. However, because printing with common color ink needs to be performed in a superimposing manner onto an image which has previously been formed in a mesh shape with metal ink (superimposing printing may be performed in the reverse order in some case), it takes a longer time to complete printing in comparison with printing performed only with color ink. That is to say, the method has a problem in that printing speed is slow.

### SUMMARY

An advantage of some aspects of the invention is to provide a print apparatus and a print method so as to realize metallic printing with a desirable metal gloss and with a desirable color hue while avoiding decrease in printing speed in the case where printing using color ink and metal ink is performed.

In order to achieve the above advantage, a print apparatus according to one of main aspects of the invention includes a color ink ejecting portion that ejects color ink and a metal ink ejecting portion that ejects metal ink, and prints an image using both color print data that is created based on color image data indicating a color image and specifies pixels to which the color ink is ejected and pixels to which the color ink is not ejected, and metallic print data that is created based on metallic image data indicating a metallic image and specifies pixels to which the metal ink is ejected and pixels to which the metallic ink is not ejected. In the print apparatus, in the case where there exists an overlap portion of the color image and the metallic image, it is preferable that the pixels to which the color ink is ejected in the color print data and the pixels to which the metal ink is ejected in the metallic print data not overlap each other.

With such print apparatus, metallic printing with desirable metal gloss and with a desirable hue can be obtained while avoiding decrease in printing speed in the case where printing with color ink and metal ink is performed.

In the print apparatus according to another aspect of the invention, it is preferable that the metallic print data be created by thinning out the data of predetermined pixels among the pixels that configure the metallic image in the metallic image data, and the color print data be created by thinning out the data of pixels other than the pixels which correspond to the predetermined pixels among the pixels that configure the color image in the color image data.

With such print apparatus, print data in which forming positions of color ink dots and metal ink dots do not overlap each other can be created, thereby making it possible to form a color image and a metallic image simultaneously.

The print apparatus according another aspect of the invention, it is preferable that the metal ink be ejected to pixels on an edge portion of the metallic image in the overlap portion of the color image and metallic image.

With such apparatus, a contour portion of the metallic image can be clearly printed.

In the print apparatus according to another aspect of the invention, it is preferable that a pixel to which neither the metal ink nor the color ink is ejected be present between a pixel to which the metal ink is ejected and a pixel to which the color ink is ejected in the overlap portion.

With such print apparatus, as a gap is generated between the metallic image and color image, it is possible to suppress bleeding, color mixing, or the like between metal ink dots and color ink dots.

In the print apparatus according to another aspect of the invention, in the case where the average of tone values of the pixels configuring the color image is greater than a predetermined reference tone value, it is preferable that the metal ink ejected to the overlap portion become larger in quantity.

With such print apparatus, as an ejection quantity of metal ink can be adjusted in accordance with color density of a background color image, it is possible to print a metallic image with a steady color hue.

In the print apparatus according to another aspect of the invention, in the case where there exists data of characters to be printed with the metal ink in the overlap portion, it is preferable that the metal ink be ejected to pixels configuring the characters, and the color ink be not ejected thereto.

With such print apparatus, characters printed with metal ink do not blur, and can be seen with clarity. [00181A print apparatus according to an aspect of the invention includes a color ink ejecting portion that ejects color ink and a metal ink ejecting portion that ejects metal ink containing metal particles, and prints an image by forming color ink dots on a medium through ejecting the color ink from the color ejecting portion based on color image data indicating a color image, and forming metallic ink dots on the medium through ejecting the metal ink from the metal ink ejecting portion based on metallic image data indicating a metallic image. In the print apparatus, in the case where there exists an overlap portion of the color image and the metallic image, it is preferable that the color ink dots and the metal ink dots not overlap each other.

With such apparatus, in the case where printing using color ink and metal ink is performed, metallic printing with a desirable metal gloss and with a desirable color hue can be realized while avoiding decrease in printing speed.

A print method according to an aspect of the invention includes: ejecting color ink from a color ink ejecting portion and also ejecting metal ink containing metal particles from a metal ink ejecting portion; creating color print data that specifies pixels to which the color ink is ejected and pixels to which the color ink is not ejected based on color image data indicating a color image and also creating metallic print data that specifies pixels to which the metal ink is ejected and pixels to which the metal ink is not ejected based on metallic image data indicating a metallic image; and preventing the pixels to which the color ink is ejected in the color print data and the pixels to which the metallic ink is ejected in the metallic print data from overlapping each other in the case where there exists an overlap portion of the color image and the metallic image.

### BRIEF DESCRIPTION OF THE DRAWINGS

The invention will be described with reference to the accompanying drawings, wherein like numbers reference like elements.

FIG. 1 is a block diagram illustrating the overall configuration of a recording system.

FIG. 2A is a descriptive view of the configuration of a printer according to an embodiment of the invention; FIG. 2B is a descriptive side view of the configuration of the printer according to the embodiment.

FIG. 3 is a descriptive cross-sectional view of a head.

FIG. 4 is a descriptive view of nozzles provided in a head.

FIG. 5 is a conceptual view of an image to be printed.

FIG. 6 is a flowchart illustrating a print process according to a first embodiment of the invention.

FIG. 7 is a flowchart illustrating a specific processing flow of dot-thinning-out processing.

FIGS. 8A through 8C are views illustrating examples of dot-thinning-out patterns in an overlap portion of a metallic image and a color image.

FIGS. 9A through 9C are descriptive views illustrating a method that specifies pixels to be thinned out in image data.

FIGS. 10A and 10B are descriptive views illustrating an example of a case where a dot-thinning-out pattern is changed.

FIG. 11A is a view illustrating an example of a case where an edge portion of a metallic image is thinned out; FIG. 11B is a view illustrating an example of a case where the edge portion of the metallic image is not thinned out.

FIG. 12 is a descriptive view illustrating an example of a case where a space (gap) is provided between a metallic image and a color image.

FIG. 13 is a flowchart illustrating dot-thinning-out processing according to a second embodiment of the invention.

FIG. 14A is a descriptive view illustrating a state in which pixels to be thinned out are specified when a background tone value is greater than a reference tone value; FIG. 14B is a descriptive view illustrating a state in which pixels to be thinned out are specified when the background tone value is equal to or less than the reference tone value.

FIG. 15 is a flowchart illustrating dot-thinning-out processing according to a third embodiment of the invention.

FIG. 16 is a view illustrating an example of an image to be printed in the third embodiment.

FIG. 17 is a view illustrating an example of an image to be printed in a fourth embodiment.

### DESCRIPTION OF EXEMPLARY EMBODIMENTS

### Print Apparatus Basic Configuration

A print apparatus according an embodiment of the invention will be explained exemplifying an ink jet printer (printer 1).

### Printer Configuration

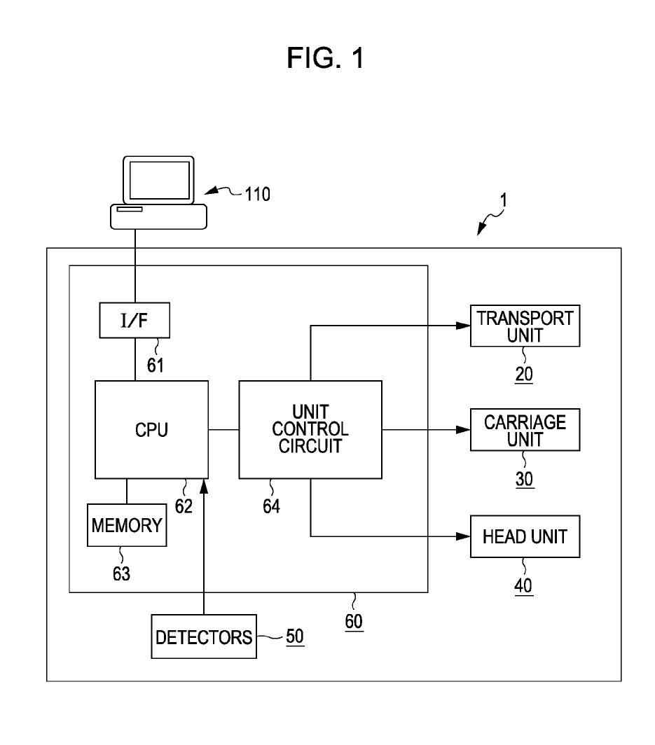

FIG. 1 is a block diagram illustrating the overall configuration of the print apparatus.

The printer 1 is a print apparatus that records (prints) characters, images, and the like on media such as paper, cloth, film and so on, and is communicably connected to a computer 110 which is an external apparatus.

A printer driver is installed in the computer 110. The printer driver is a program that makes a display device display a user interface thereon and converts image data outputted by an application program to record data. The printer driver is recorded in a recording medium (recording medium which a computer can read) such as a flexible disk (FD), CD-ROM, or the like. In addition, the printer driver can be downloaded to the computer 110 via the Internet. The program is configured of a code that implements various functions.

The computer 110 is a record apparatus controller that outputs record data to the printer 1 in accordance with an image to be recorded so as to make the printer 1 record the image.

The printer 1 includes a transport unit 20, a carriage unit 30, a head unit 40, detectors 50, and a controller 60. The controller 60 controls each unit according to record data received from the computer 110 as the record apparatus controller, and records an image on a medium. Conditions inside the printer 1 are monitored by the detectors 50, and the detectors 50 output detection results to the controller 60. The controller 60 controls each unit according to the detection results outputted by the detectors 50.

### Transport Unit 20

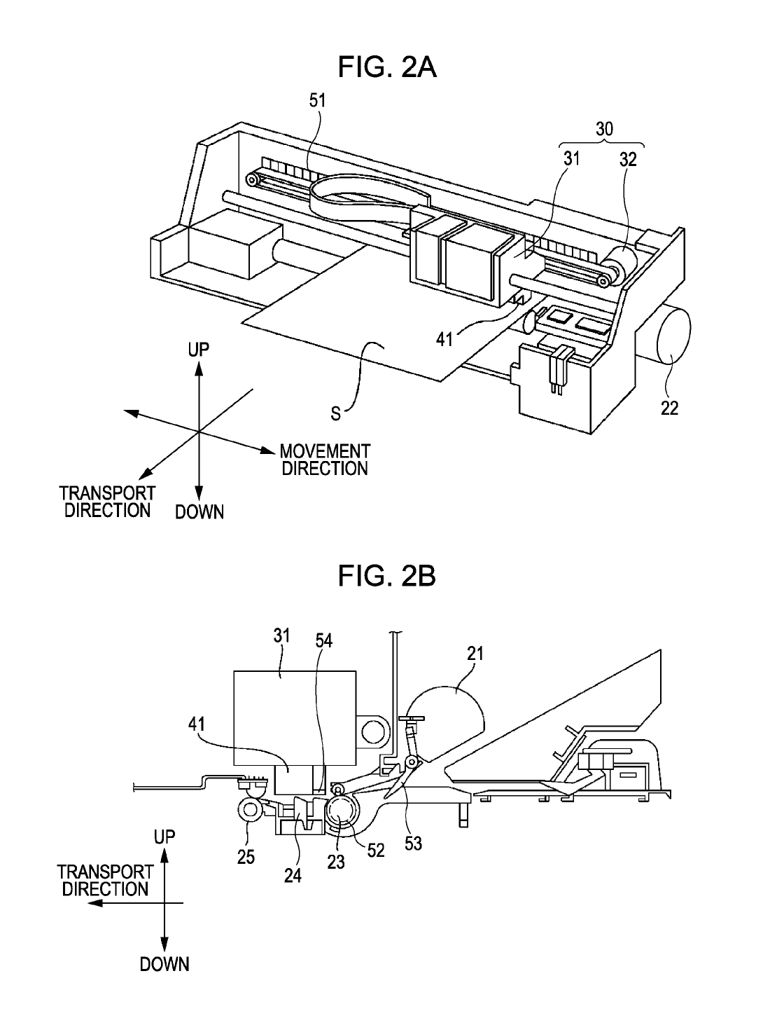

FIG. 2A is a descriptive view illustrating the configuration of the printer 1 according to the embodiment; FIG. 2B is a descriptive side view illustrating the configuration of the printer 1 according to the embodiment.

The transport unit 20 transports a medium (e.g., paper S or the like) in a predetermined direction (hereinafter referred to as a transport direction). Note that the transport direction is a direction that intersects with a movement direction of a carriage. The transport unit 20 includes a paper feed roller 21, a transport motor 22, a transport roller 23, a platen 24, and a paper discharge roller 25 (FIGS. 2A and 2B).

The paper feed roller 21 is a roller that feeds the paper S inserted into a paper insertion opening to the inside of the printer 1. The transport roller 23 is a roller that transports the paper S fed by the paper feed roller 21 to a recordable region, and is driven by the transport motor 22. Operation of the transport motor 22 is controlled by the controller 60 on the printer side. The platen 24 is a member that supports the paper S on which recording is currently being performed from the reverse side of the paper S. The paper discharge roller 25 is a roller that discharges the paper S to the outside of the printer 1, and is provided on the downstream side in the transport direction with respect to the recordable region.

### Carriage Unit 30

The carriage unit 30 moves (also called “scans”) a carriage 31, on which the head unit 40 is mounted, in a predetermined direction (hereinafter referred to as a movement direction). The carriage unit 30 includes the carriage 31 and a carriage motor 32 (also called a CR motor) (FIGS. 2A and 2B).

The carriage 31 can move back and forth in the movement direction, and is driven by the carriage motor 32. Operation of the carriage motor 32 is controlled by the controller 60 on the printer side. Further, the carriage 31 holds a cartridge that accommodates liquid with which to record an image (hereinafter, also called ink) in a detachable manner.

### Head Unit 40

The head unit 40 ejects ink onto the paper S. The head unit 40 includes a head 41 having a plurality of nozzles. The head 41 is mounted in the carriage 31, and moves in the movement direction together with the carriage 31 when the carriage 31 moves in the movement direction. A dot line (raster line) is formed along the movement direction by the head 41 intermittently ejecting ink during its movement in the movement direction.

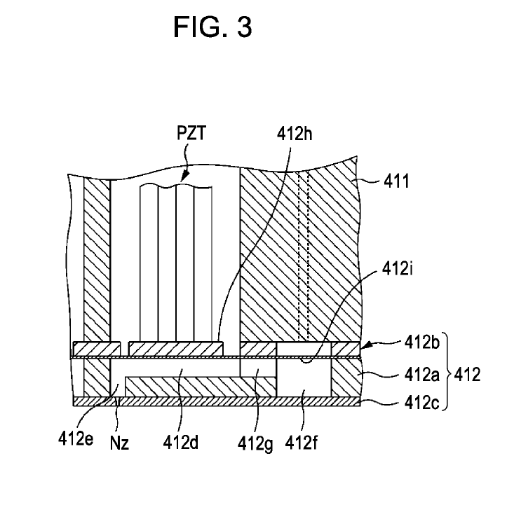

FIG. 3 is a cross-sectional view illustrating the structure of the head 41. The head 41 includes a case 411, a flow path unit 412, and piezo elements PZT. The case 411 accommodates the piezo elements PZT, and the flow path unit 412 is jointed to the lower face of the case 411. The flow path unit 412 includes a flow path forming plate 412a, an elastic plate 412b, and a nozzle plate 412c. In the flow path forming plate 412a, a grove as a pressure chamber 412d, a pass-through opening as a nozzle communication opening 412e, another pass-through opening as a common ink chamber 412f, and another groove as an ink supply path 412g are formed. The elastic plate 412b includes an island portion 412h to which a tip of each piezo element PZT is jointed. Furthermore, the island portion 412h is surrounded by an elastic region formed of an elastic film 412i. Ink accommodated in the ink cartridge is supplied via the common ink chamber 412f to the pressure chamber 412d corresponding to each nozzle Nz. The nozzle plate 412c is a plate in which the nozzle Nz is formed.

The piezo elements PZT have a plurality of piezo elements (drive elements) in a comb-toothed form, and an equal number of piezo elements are provided to correspond to the nozzles Nz. When a drive signal COM is applied to the piezo element by a wiring substrate (not shown) on which a head controller HC and the like are mounted, the piezo element expands or contracts in an upward-downward direction in accordance with an electrical potential of the drive signal COM. When the piezo element PZT expands or contracts, the island portion 412h is pushed to a direction into the press chamber 412d or pulled to the opposite direction. At this time, the elastic film 412i surrounding the island portion 412h deforms and causes the pressure in the pressure chamber 412d to increase or decrease so as to eject ink droplets through the nozzles.

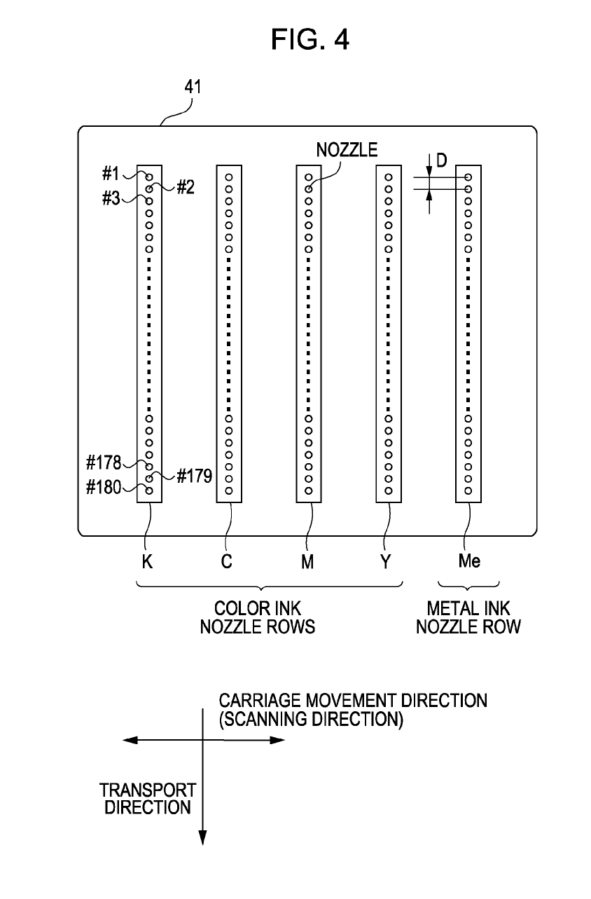

FIG. 4 is a descriptive view illustrating the nozzles Nz provided on the lower face of the head 41. A plurality of rows of color ink nozzles and a row of metal ink nozzles Me to eject metal ink are formed in a nozzle face. The plurality of rows of color ink nozzles are configured of a row of yellow nozzles Y to eject yellow ink, a row of magenta nozzles M to eject magenta ink, a row of cyan nozzles C to eject cyan ink, and a row of black nozzles K to eject black ink. As shown in FIG. 4, each row of KCMY and Me nozzles is configured such that the nozzles Nz as ejection openings through which each color of ink is ejected are arranged at a predetermined interval D in the transport direction. Each nozzle row includes 180 nozzles Nz from #1 to #180. Note that the number of nozzles actually arranged in each nozzle row is not limited to 180, and may be, for example, 90 or 360. Further, although the nozzle rows are arranged in parallel to each other in the movement direction in FIG. 4, the nozzle rows may have a configuration in which they are arranged each other orthogonally to the transport direction. In addition, each color of KCMY and Me may not be assigned a single nozzle row, and in turn a configuration may be provided such that each color is allowed to have a plurality of nozzle rows.

### Detectors 50

The detectors 50 monitor the conditions of the printer 1, and include a linear encoder 51, a rotary encoder 52, a paper detection sensor 53, an optical sensor 54, and the like (FIGS. 2A and 2B).

The linear encoder 51 detects a position of the carriage 31 in the movement direction. The rotary encoder 52 detects a rotational amount of the transport roller 23. The paper detection sensor 53 detects a position of the leading end of the paper S being fed. Using a light-emitting unit and a light-receiving unit that are attached to the carriage 31, the optical sensor 54 detects presence/absence of the paper S at the opposing position; for example, the optical sensor 54 detects an edge position of the paper during its movement, and can detect the width of the paper. In addition, the optical sensor 54, depending on operational conditions, can also detect the leading end of the paper S (an edge of the paper S on the downstream side in the transport direction, also called a top end) and the following end of the paper S (an edge of the paper S on the upstream side in the transport direction, also called a bottom end).

### Controller 60

The controller 60 is a control unit (controller) to control the printer 1, and includes an interface unit 61, a CPU 62, a memory 63, and a unit control circuit 64 (FIG. 1).

The interface unit 61 sends/receives data between the computer 110 as an external apparatus and the printer 1. The CPU 62 is an arithmetic processing unit to control the printer 1 as a whole. The memory 63 provides a region for storing programs of the CPU 62, working areas, and so on, and is configured of storage elements such as RAM, EEPROM, and the like. Further, the CPU 62 controls each of the units such as the transport unit 20 and the like via the unit control circuit 64 according to the program stored in the memory 63.

### Print Operation of Printer

Print operation of the printer 1 will be briefly explained. The controller 60 receives a print instruction from the computer 110 through the interface unit 61 and controls each unit so as to perform paper feed processing, dot forming processing, transport processing, and so on.

The paper feed processing is a processing to feed paper to be printed into the inside of the printer 1 and set the paper to a print start position (also called a cue position). The controller 60 makes the paper feed roller 21 rotate to send the paper to be printed down to the transport roller 23. Subsequently, the transport roller 23 is rotated so as to set the paper sent from the paper feed roller 21 to the print start position.

The dot forming processing is a processing to intermittently eject ink from the head moving along the movement direction (scanning direction) so as to form dots on a surface of paper. The controller 60 makes the carriage 31 move in the movement direction, and causes ink to be ejected from the head 41 in accordance with print data while the carriage 31 is moving. When the ejected ink droplet lands on a surface of paper, a dot is formed on the surface of paper; thus, a dot line which is configured of a plurality of dots formed along the movement direction is formed on the surface of paper.

The transport processing is a processing to move paper along the transport direction relative to the head 41. The controller 60 makes the transport roller 23 rotate to transport the paper in the transport direction. With the transport processing, the head 41 can form dots on a line position different from the line position of the dots that have been formed by the dot forming processing mentioned above.

The controller 60 alternately repeats the dot forming processing and the transport processing until there exists no data to be printed, during which an image configured of dot lines is gradually printed on the paper. In the case where there exists no data to be printed, the paper discharge roller 25 is rotated to discharge the paper. Note that judgment whether or not to discharge the paper may be made based on a discharge command included in the print data.

If printing is needed to be performed on the next paper, the processings described above are repeated; if not needed, the print operation is ended.

There are two modes in the print operation of the printer 1: one is a “unidirectional printing” and the other is a “bidirectional printing.” In the unidirectional printing, ink droplets are ejected during a forward movement time in which the head 41 moves from the right side (named a home position) toward the left side of the movement direction (scanning direction), whereas ink droplets are not ejected during a backward movement time in which the head 41 moves from the left side toward the right side of the movement direction. On the other hand, in the bidirectional printing, ink droplets are ejected during both the forward movement time and the backward movement time. Note that a print method described in the embodiment can be applied to either print operation of the “unidirectional printing” and “bidirectional printing.”

### Metal Ink Used For Printing

Metal ink contains silver particles, aluminum particles, or the like as metal particles. A bright metal gloss can be obtained on a printed surface by using metal ink that contains aluminum particles. However, aluminum particles are likely to be oxidized and there exists a risk such that the printed surface becomes whitened as time passes. On the other hand, metal ink that contains silver particles has a problem in that the color of metal gloss on a printed surface is likely to become darker and cost is higher in comparison with ink that contains aluminum particles; however, metal ink containing silver particles has an advantageous property that it is unlikely to be oxidized and shows excellent stability. Metal ink to be used for printing can be selected according to usage of the printing; it is to be noted that in each of the embodiments according to the invention, printing that employs metal ink containing silver particles is described. According to a print method in each of the embodiments that will be explained below, it is possible to solve the above-mentioned problems of higher cost, darkness of color, and the like when using the metal ink containing silver particles.

As a solvent of metal ink, purified water or ultrapure water is used such as ion-exchange water, ultra-filtration water, reverse osmosis water, distilled water, and the like. Some ions or the like may be present in the water as long as they do not interfere with dispersion of metal particles. Further, surfactants, polyhydric alcohol, pH regulators, resins, color materials, and the like may be contained therein if necessary.

Silver particles contained in an ink composite according to the embodiment are particles whose major constituent is silver. The silver particle may contain, for example, other metal, oxygen, carbon and the like, as accessory constituents. The fineness of silver in the silver particle may be more than 80%, for example. The silver particle may be an alloy of silver and other metal. Note that silver particles contained in the ink composite may be in a colloid (particle colloid) state. If the silver particles are dispersed in the colloid state, dispersibility of the silver particles is further improved, which can contribute to improvement in preservation stability of the ink composite, for example.

In a grain size accumulation curve of silver particles, the particle size d90 is a particle size equal to or greater than 50 nm and equal to or less than 1 μm. The grain size accumulation curve is a type of curved line obtained in the following manner: first, measure the diameters of silver particles dispersed in liquid such as an ink composite or the like and count the silver particles present in the liquid; thereafter, perform statistical processing on the measurement and count results to obtain the curved line. As for the grain size accumulation curve according to the embodiment, the horizontal axis represents diameters of particles and the vertical axis represents accumulated values (integral values) of calculation results of mass of particles. To be more specific, each mass of particles is a product of volume of each particle, density of each particle, and the number of particles when each particle is considered to have a sphere shape; each integral value of mass of particles is sequentially calculated in ascending order of size of a particle diameter. Here, in the case where the vertical axis in the grain size accumulation curve is normalized (the total mass of measured particles is considered to be 1), the particle size d90 is a value on the horizontal axis corresponding to a value of 90% (0.90) on the vertical axis. That is, the particle size d90 refers to a particle diameter. In this case, the particle diameter of silver may be a diameter of a silver particle itself; if silver particles are dispersed in a colloid state, the particle diameter may be a diameter of the particle in the colloid state.

The grain size accumulation curve of silver particles can be obtained by using, for example, a particle size distribution measurement instrument based on the dynamic light scattering method. The dynamic light scattering method irradiates laser light to silver particles being dispersed and receives the scattered light thereof with a photon detector. In general, silver particles being dispersed normally make Brownian motion. The motion velocity of a silver particle becomes larger as the particle diameter thereof becomes larger, and becomes smaller as the particle diameter becomes smaller. When laser light is irradiated to the silver particles making Brownian motion, fluctuation corresponding to Brownian motion of the silver particles is observed in the scattered light. By measuring the fluctuation, obtaining an autocorrelation function with the photon correlation method or the like, and using the cumulant method, the histogram analysis method and the like, diameters of silver particles and the frequency (number) of silver particles corresponding to each of the diameters can be obtained. Since the dynamic light scattering method is particularly suited to the measurement of a sample containing submicron-sized silver particles, the grain size accumulation curve can be obtained comparatively with ease by using the dynamic light scattering method. As a particle size distribution measurement instrument based on the dynamic light scattering method, Nanotrac UPA-EX150 (made by NIKKISO CO., LTD.), ELSZ-2, DLS-8000 (both made by OTSUKA ELECTRONICS CO., LTD.), LB-550 (made by Horiba, LTD.), and the like can be cited, for example.

### First Embodiment

In a first embodiment according to the invention, an image in which a metallic image and a color image coexist is printed using metal ink and color ink. At this time, if there exists an overlap portion of the metallic image and the color image, printing on the overlap portion is so performed that both the metal ink and the color ink are not ejected to the same pixel. In other words, printing is performed such that metal ink dots and color ink dots formed on a medium do not overlap each other in each pixel unit.

### Print Target Image

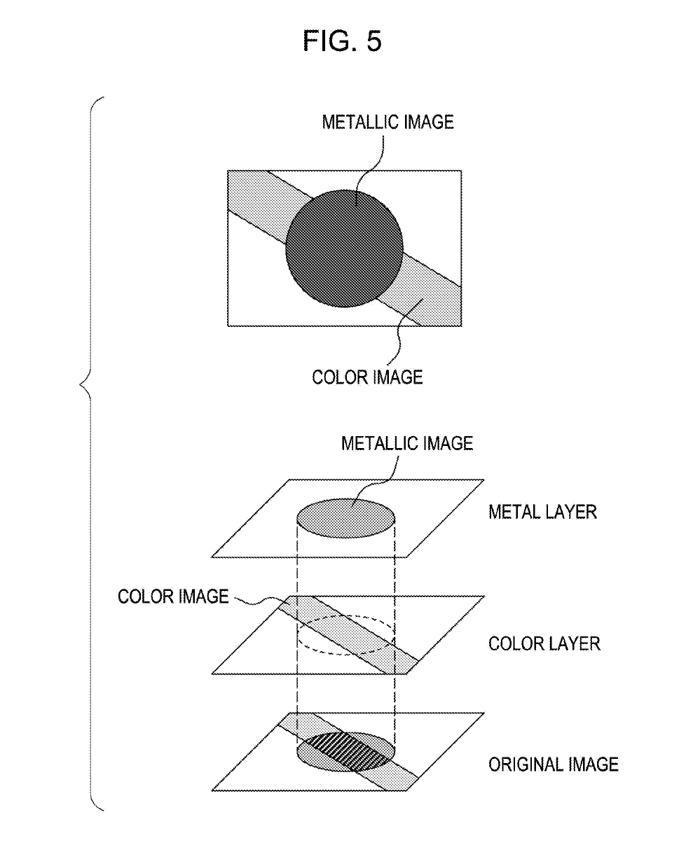

FIG. 5 is a conceptive view of an image to be printed. An image (original image) as a print target in the first embodiment is configured of a metallic image portion printed with metallic ink and a color image portion printed with color ink, as illustrated at the left side of FIG. 5. Note that the color image is expressed with three colors of RGB, and printed with four ink colors of KCMY.

For the sake of simplicity in explanation, it is assumed that the original image is configured of two layers, i.e., a metal layer where a metal image is formed, and a color layer where a color image is formed. Although the color layer can actually be divided into three color images of RGB, it is assumed hereinbelow that the color layer is configured of a single type of color image. As shown at the right side of FIG. 5, the original image as a print target is formed by superimposing the metal layer and color layer. Note that in FIG. 5, a region indicated by hatched lines in the original image is an overlap region of the metal image and the color image.

In the case where there exits an overlap region of a color image and a metal image as describe above, a print method of the past technique first forms the metal image on a medium by printing the metal image indicated on a metal layer. After forming the metal image, the print method of the past technique, in general, prints the color image indicated on a color layer while superimposing the color image on the metal image. However, with this method, since printing has to be performed twice, i.e., printing of the metal layer and printing of the color layer, time to perform and complete the printing of two layers is longer than the time of a normal color printing that uses only color ink.

In the embodiment, as described above, in the case where there exists an overlap portion of the metallic image and color image, since printing is controlled to be performed once in which the ink dots do not overlap each other in the overlap portion, it is possible to shorten the print time while avoiding decrease in print image quality.

### Print Process

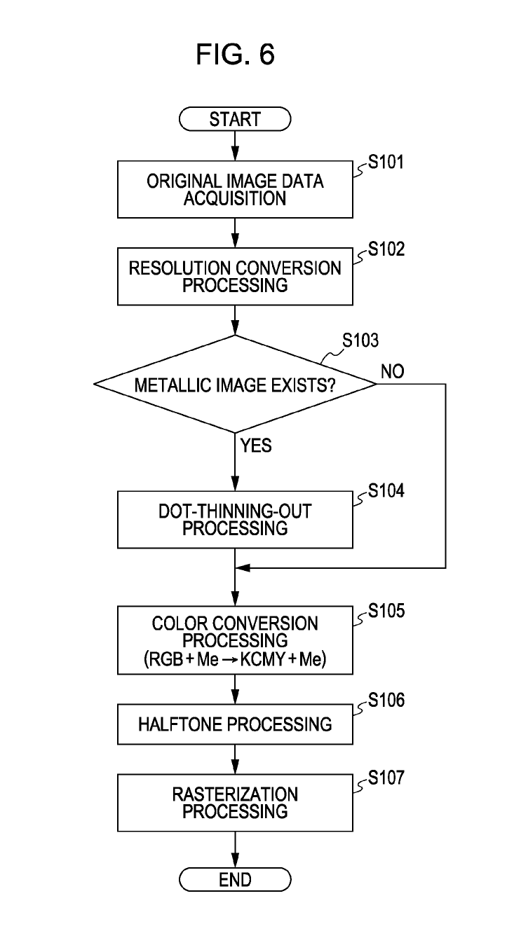

A specific description of a print process is given below. FIG. 6 is a flowchart of the print process according to the first embodiment. The print process is performed by executing steps S101 through S107. Each step is executed based on a command sent from the printer driver installed in the computer 110.

The printer driver receives original image data from an application program, converts the received data to print data in a form that the printer 1 can interpret, and outputs the print data to the printer 1. The printer driver performs resolution conversion processing, color conversion processing, halftone processing, rasterization processing and so on, during the time when the printer driver converts the original image data to the print data. Then, color image printing and metallic image printing can be performed simultaneously by experiencing step S103 (judgment of presence/absence of a metallic image) and step S104 (dot-thinning-out processing) which are explained later.

Hereinafter, details of various processings performed by the printer driver are described.

Before the start of printing, the computer 110 and the printer 1 are connected to each other first (see FIG. 1), then the printer driver stored in a CD-ROM which is bundled to the printer 1 (or, the printer driver which has been downloaded from a home page of the printer manufacturer) is installed in the computer 110. The printer driver includes a code that makes the computer 110 execute each processing in FIG. 6.

When printing is started upon receiving a print request from a user through the application program, the printer driver is called in to receive image data (original image data) as a print target from the application program (S101). Subsequently, resolution conversion processing is performed on the image data (S102).

The resolution conversion processing (S102) converts image data (text data, image data, and the like) to image data having resolution with which printing on a medium is performed. For example, when a print resolution of 720×720 dpi is requested, image data in vector form received from the application program is converted to image data in bit map form with a resolution of 720×720 dpi. Each pixel data of the image data after resolution conversion is configured of two kinds of data, i.e., data with each of tones expressed by the RGB color space (e.g., 256 tones), and data with tones expressed by the metallic (Me) color space (e.g., 256 tones).

Next, the printer driver judges, using the original image data, whether or not there exists a metallic image (S103). It is assumed in this embodiment that an image including a metallic image therein is printed; however, in the case of a normal color print which does not include a metallic image, printing may be performed with a method of the past technique. Therefore, at step S103, it is judged whether or not there exists a metallic image; if a metallic image is included in the original image data, the process goes to dot-thinning-out processing (S104); if not included, the process goes to color conversion processing (S105) skipping the dot-thinning-out processing (S104).

If it is judged at step S103 that a metallic image is included in the original image data, the dot-thinning-out processing is performed on predetermined pixels of the metallic image and the color image, respectively (S104). The dot-thinning-out processing, in the case where there exists an overlap region of the metallic image and color image (see FIG. 5), thins out part of the dots (pixel data to form dots) in the overlap region so as to create print data in which ink is not ejected to the thinning-out target pixels. Accordingly, print data in which metal ink dots and color ink dots do not overlap each other in each pixel unit can be created. As an overlap pixel between the metal ink dot and color ink dot is not present, printing of the metallic image and printing of the color image can be performed simultaneously, thereby making it possible to solve problems such as a longer print time and the like.

Specific operation of the dot-thinning-out-processing will be described later.

Next, the printer driver performs the color conversion processing (S105). The color conversion processing converts image data so that the data comes to conform to a color space of ink colors of the printer 1. In this case, image data of the “Me+RGB” color space is converted to image data of the “Me+KCMY” color space. As the metal ink color (Me) cannot be expressed by any combination of KCMY colors, it is treated as a special color and does not experience the color conversion processing. The color conversion processing is performed based on 3D-LUT in which tone values of RGB data and tone values of KCMY data are related to each other; thus, image data of the KCMY color space is obtained. Note that the pixel data having experienced the color conversion processing is 8-bit data of 256 tones expressed by the “Me+KCMY” color space.

After the color conversion processing (S105), the printer driver performs halftone processing (S106). The halftone processing converts data with a large number of tones to data with a smaller number of tones that can be formed by the printer 1. In this case, print image data with 256 tones is converted to 1-bit data representing two tones, 2-bit data representing four tones, or the like. The dither method, the error diffusion method, and the like are known as methods of halftone processing, and the halftone processing performed in the embodiment is similar to such methods. Resolution of the data having experienced the halftone processing is equal to recording resolution (e.g., 720×720 dpi). In the image data having experienced the halftone processing, 1-bit or 2-bit pixel data corresponds to each pixel, and represents a dot forming condition (presence/absence of a dot, size of a dot) at each pixel.

Next, the printer driver performs rasterization processing (S107). The rasterization processing changes the alignment order of pixel data on the print image data to the order in which each data will be transferred to the printer 1. For example, each pixel data is re-ordered in accordance with the alignment order of nozzles in each nozzle row. Thereafter, the printer driver creates print data by adding control data for controlling the printer 1 to pixel data, and transmits the created print data to the printer 1.

The printer 1 performs print operation according to the print data received. To be more specific, the controller 60 of the printer 1 controls the transport unit 20 and the like according to the control data in the received print data, and also controls the head unit 40 according to the pixel data in the print data so as to make color ink and metal ink be ejected through each of the nozzles provided in the head 41.

### Details of Dot-Thinning-Out Processing (S104)

Details of the dot-thinning-out processing (S104) are described below. In this embodiment, as mentioned above, both metal ink dots and color ink dots are not ejected to the same pixel on a medium in an overlap region of a metallic image and a color image (hereinafter, also simply called as an overlap region), thereby making it possible to print the metallic image and the color image simultaneously. Therefore, print data of a color ink dot needs to be thinned out at a pixel to which a metal ink dot is expected to be ejected, whereas print data of a metal ink dot needs to be thinned out at a pixel to which a color ink dot is expected to be ejected.

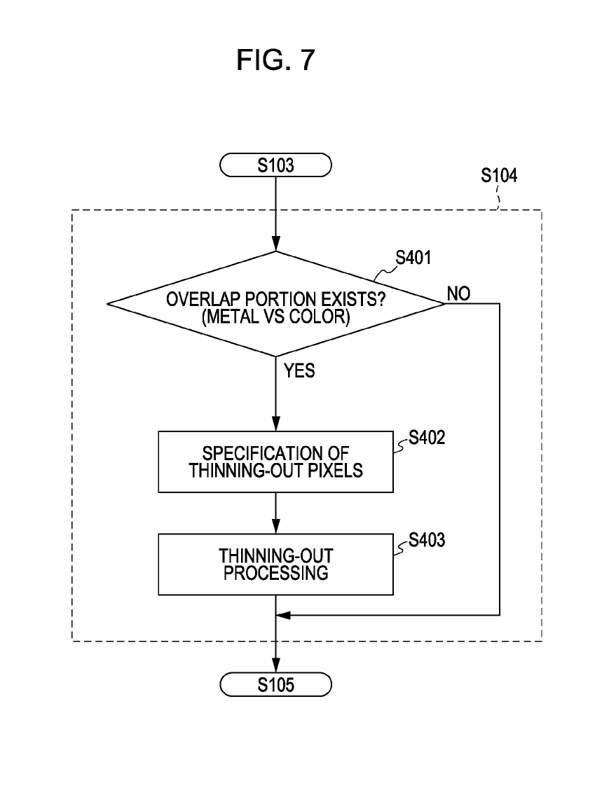

FIG. 7 shows a specific processing flow of the dot-thinning-out processing. The dot-thinning-out processing (S104) is performed by executing steps S401 through S403. Judgment of Presence/Absence of Overlap Region (S401)

First, it is judged whether or not there exists an overlap region of the metallic image and color image. Even when the original image data includes both the metallic image and color image, if no overlap portion of the two images is present, the dot-thinning-out processing (S104) is ended and the process moves to the next step, i.e., the color conversion processing (S105) because there is no need to thin out dots and the like. On the other hand, if there exists an overlap region, processing to thin out predetermined dots is performed on the metallic image data and the color image data, respectively.

Here, the case in which a metallic image and a color image “overlap” each other is a case such that the position of a pixel (pixel having a tone value other than zero with respect to the Me color) representing the metallic image on the metal layer and the position of a pixel (pixel having a tone value other than zero with respect to at least one of RGB colors) representing the color image on the color layer overlap each other. For example, if the tone value of Me is 128 and the tone value of R is 256 at a certain pixel A, the metallic image and color image overlap each other at the pixel A. If the tone value of Me is 64 and the tone values of RGB are all zero at a certain pixel B, the metallic image and color image do not overlap each other at the pixel B.

The printer driver compares the tone value of Me and the tone values of RGB at every pixel of the image data having experienced the resolution conversion processing (S102) so as to detect an overlap pixel between the metallic image and color image. If an overlap pixel is detected, positional information on the overlap pixel is temporarily stored in the memory 63 and the process goes to the next step, i.e., specification of thinning-out pixels (S402). Specification of Thinning-out Pixels, Thinning-out Processing (S402, S403)

Pixels to be thinned out are specified with respect to the metallic image data and color image data, respectively, and processing to thin out the pixel data is actually performed. Predetermined pixels selected from among the pixels that configure the overlap region detected in step S401 become the thinning-out target pixels. In the embodiment, in order to create print data such that both metal ink and color ink are not ejected to the same pixel being overlapped, pixels in different positions between the metallic image data and color image data need to be thinned out. For example, in the metallic image, if a pixel A in a predetermined position within an overlap region of the color image and metallic image is specified as a thinning-out target, the same pixel A in the color image does not need to be thinned out. Similarly, in the color image, if a pixel B in a predetermined position in the overlap region of the metallic image and color image is specified as a thinning-out target, the same pixel B in the metallic image does not need to be thinned out. In other words, if thinning-out target pixels can be specified in either one of the metallic image and the color image, thinning-out target pixel can also be specified in the other image.

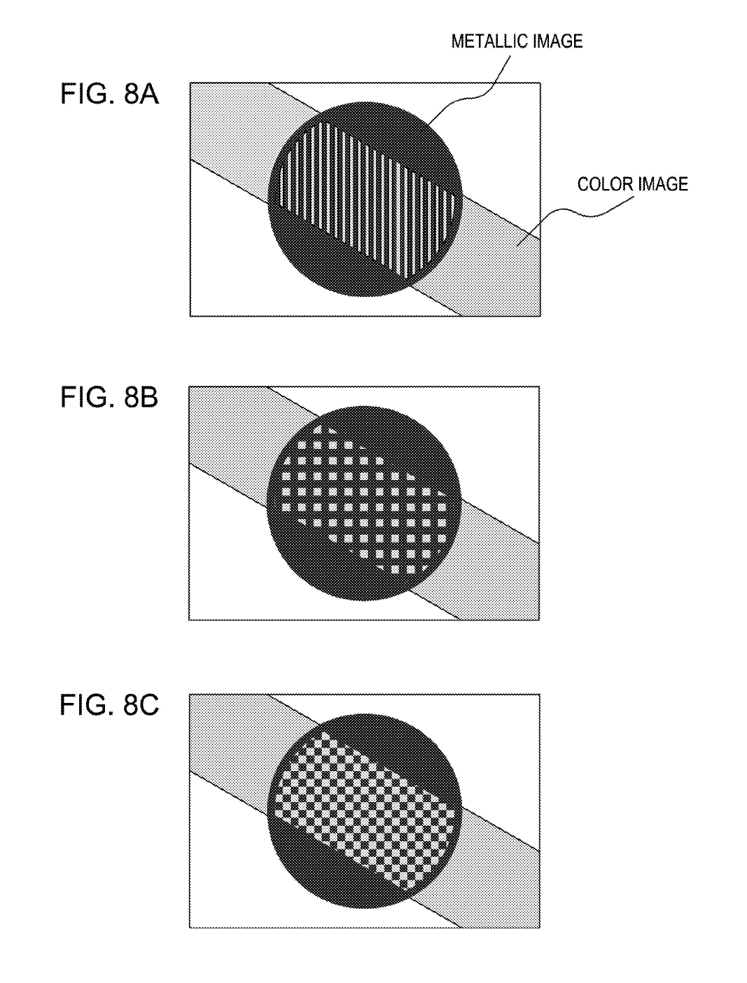

FIGS. 8A through 8C illustrate examples of dot-thinning-out patterns in an overlap portion of a metallic image and a color image. FIG. 8A is an example of an image pattern that is printed when image data of the metallic image and image data of the color image are respectively thinned out in stripe form. FIG. 8B is an example of an image pattern that is printed when dots are thinned out so that the metallic image becomes lattice-shaped. FIG. 8C is an example of an image pattern that is printed when dots are thinned out so that the metallic image becomes checkered. Note that, in order to facilitate understanding of the thinning-out patterns, intervals at which dots are thinned out are made larger in the drawings than the actual ones.

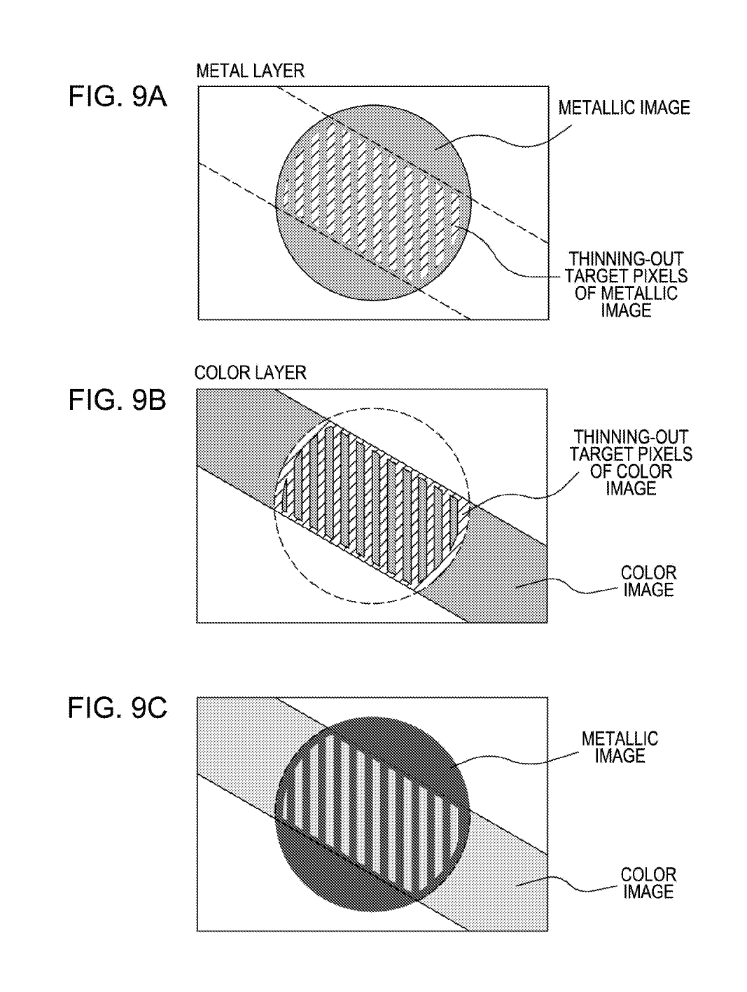

An example of a case where print data of a thinning-out pattern in stripe form, as shown in FIG. 8A, is created is described below. FIGS. 9A through 9C are descriptive views illustrating a method that specifies pixels to be thinned out in stripe form. First, the printer driver specifies each of the pixels on every other line of pixels as a thinning-out target pixel among the pixels configuring the overlap region of the metallic image on the metal layer. In the metallic image shown in FIG. 9A, portions indicated by hatched lines are thinning-out target pixels of the metallic image. Thus, in the overlap region, metallic image data is obtained in which rows of pixels whose Me tone values are not zero and rows of pixels whose Me tone values are zero (rows of pixels specified as thinning-out targets) are aligned alternately like in a stripe pattern.

Next, on the color layer, the printer driver specifies all the pixels aside from those specified as the thinning-out targets of the metallic image (pixels indicated by hatched lines in FIG. 9A) as thinning-out targets among the pixels configuring the overlap region of the color image. In the color image shown in FIG. 9B, portions indicated by hatched lines are thinning-out target pixels of the color image. That is to say, in the overlap region, all the pixels specified as pixels to which metal ink is ejected are specified as thinning-out target pixels of the color image. As a result, the color image in which the overlap region has a stripe pattern (an inverted pattern of the stripe pattern of the metallic image) is obtained.

By combining these data, print data in which positions of the pixels to which metal ink dots are ejected and positions of the pixels to which color ink dots are ejected do not overlap each other in the overlap region is obtained (FIG. 9C).

In the example mentioned above, since the pixel data on every other row of pixels is thinned out with regard to the metallic image, the metallic image is formed in a stripe shape each stripe width of which is the same as the width of a pixel. On the other hand, it is also possible to change the intervals at which pixels are thinned out so that each stripe of the metallic image (or the color image) has two pixels' worth of width, three pixels' worth of width, or the like. As for settings of thinning-out target pixels, it is desirable that a user can change the settings on a user interface (not shown) after the user has confirmed the image actually printed.

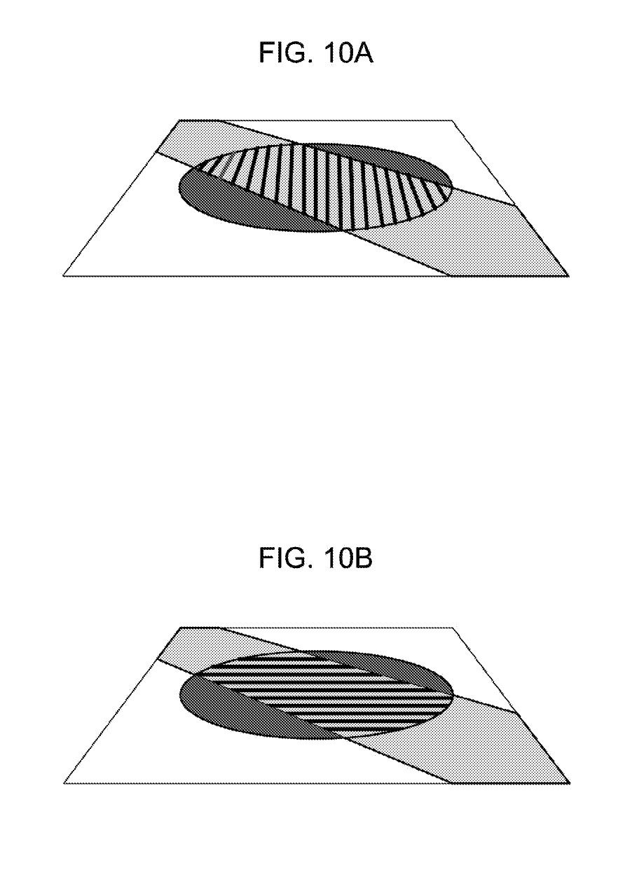

Furthermore, it is also possible to change a thinning-out pattern while taking into consideration an angle at which a printed image is seen or the like. FIGS. 10A and 10B illustrate an example of a change of a dot-thinning-out pattern. For example, in the case where a printed image is looked up from below, a vertical-stripe pattern as shown in FIG. 10A (corresponding to FIG. 8A) is not employed, but a horizontal-stripe pattern as shown in FIG. 10B is employed. In the case where an image is confirmed at an angle as shown in FIGS. 10A and 10B, a horizontal-stripe pattern (FIG. 10B) is more desirable than a vertical-stripe pattern (FIG. 10A) because intervals between the stripes are less noticeable so that the influence of thinning-out of dots can be further lessened. Note that a user may be allowed to perform such a thinning-out pattern change through the user interface.

In the case of thinning-out patterns as shown in FIGS. 8B and 8C, a dot-thinning-out method is the same as in the case of the stripe pattern shown in FIG. 8A. That is to say, in the overlap region, thinning-out target pixels of the metallic image are specified first, subsequently, pixels other than the specified ones are specified as thinning-out target pixels of the color image.

No matter which pattern is selected from among these thinning-out patterns, pixels on an edge portion of the overlap region in the metallic image are excluded from the thinning-out targets. Since the printed surface of a metallic image has a particular quality due to metal gloss, difference from the printed surface of a regular color image is more noticeable. Therefore, in the case of an image that is printed in a manner in which a metallic image is superimposed upon a color image (e.g., FIG. 5), when pixels on a boundary portion of the metallic image (pixels on a boundary portion between the metallic image and the color image) are thinned out, an impression that the metallic image is blurred as a whole is likely to be given. Accordingly, it is desirable that metal ink dots are always formed on the pixels on an edge portion of the metallic image.

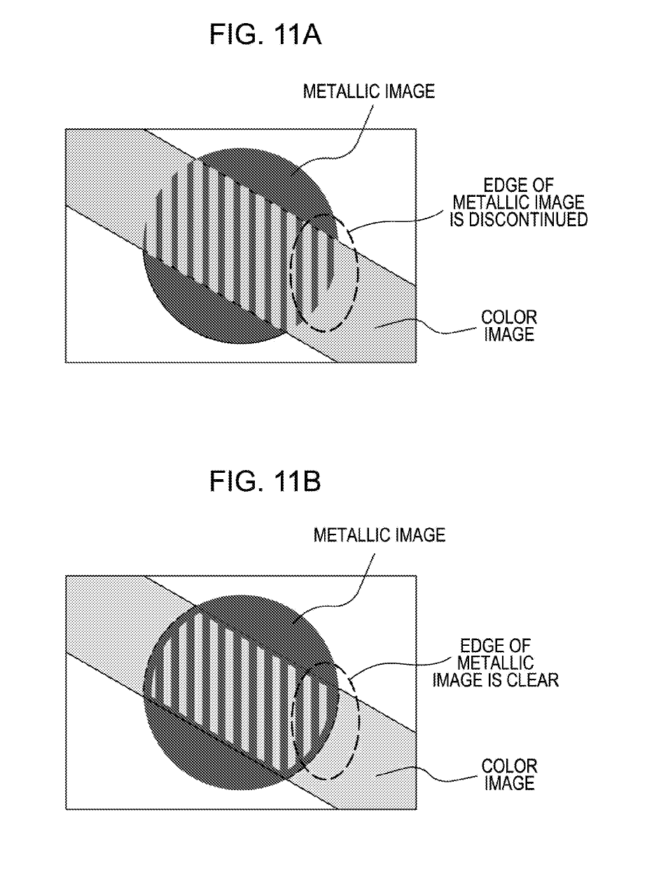

FIG. 11A shows an example of a case where an edge portion of a metallic image is thinned out. On the other hand, FIG. 11B shows an example of a case where the edge portion of the metallic image is not thinned out. As shown in FIG. 11A, in the case where the edge portion of the metallic image is included in the thinning-out targets, since the boundary between the metallic image portion and the color image portion serving as a background of the metallic image portion is discontinued intermittently, the contour of the metallic image runs into the background image so that an impression that the metallic image is blurred as a whole may be given. On the other hand, as shown in FIG. 11B, in the case where the edge portion of the metallic image is excluded from the thinning-out targets, since the boundary line between the metallic image portion and the color image portion serving as the background of the metallic image portion is printed without being discontinued, the contour of the metallic image appears clearly, thereby making it possible to print the metallic image with a sharp impression.

As described above, in this embodiment, whichever thinning-out pattern may be used (for example, in the case where any one of the patterns shown in FIGS. 8A through 8C is selected), pixels configuring an edge portion of an overlap region in the metallic image are excluded from targets of thinning-out processing.

### Effects of First Embodiment

With the print method according to the embodiment, even if a metallic image and a color image overlap each other, printing of the metallic image and printing of the color image can be performed simultaneously. Further, in the overlap portion, pixels of the metallic image are thinned out in stripe-shaped form, lattice-shaped form or the like so that the color image can be printed as well on the thinned-out portions. Accordingly, the metallic image with the same color hue can be formed as in the case where the metallic image is printed by being superimposed on the color image. This makes it possible to make the print time shorter without considerably deteriorating image quality in comparison with the methods in the past.

Further, with the past technique, a metallic image is superimposed on a color image, which causes the color (metal gloss) of the metallic image likely to be dark. In contrast, in the embodiment, printing is so performed that color ink dots and metal ink dots do not overlap each other, which suppresses the color of the metallic image from being dark. In addition, as the quantity of ejected ink is reduced by thinning out ink dots, the total quantity of ink consumed for printing can be reduced, and consequently, print costs can be reduced.

### Variation on First Embodiment

In the aforementioned first embodiment, thinning-out processing is so performed that color ink dots are certainly formed on the pixels where metal ink dots are thinned out in the overlap region of the metallic image and the color image (see FIG. 8A and the like). To rephrase, printing such that all the pixels in the overlap region are filled by the color ink dots and metal ink dots is performed. However, thinning-out processing such that spaces are provided between metal ink dots and color ink dots in the overlap portion may be performed.

In the dot-thinning-out processing (S104) of this variation, a method of specifying thinning-out targets of the color image to be performed after having specified thinning-out targets of the metallic image, differs from the method describe hereinbefore. With the method described before, all the pixels excluded from the thinning-out targets of the metallic image have been specified as the thinning-out targets of the color image (S402). That is, the color image is formed on all of the pixels specified as the thinning-out targets of the metallic image. On the other hand, in the variation, in addition to the pixels excluded from the thinning-out targets of the metallic image (i.e., pixels on which the metallic image is formed), pixels distanced one pixel's or a few pixels' worth of width outward from the pixels on a contour portion of the metallic image which are excluded from the thinning-out targets of the metallic image, are also specified as the thinning-out target pixels of the color image.

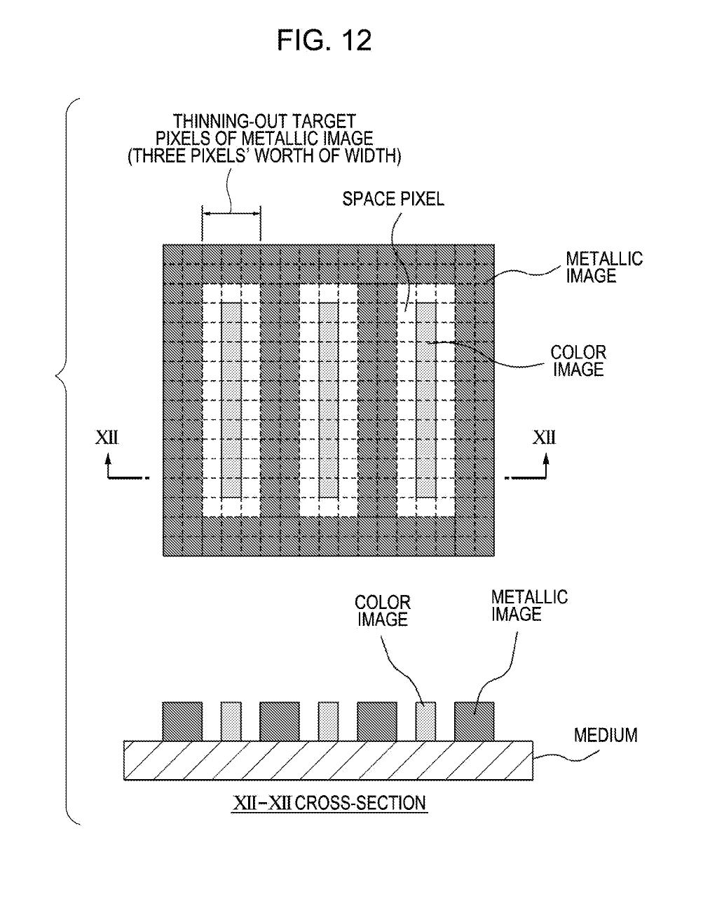

FIG. 12 is a descriptive view specifically illustrating an example of a case where a space (gap) is provided between a metallic image and a color image. In the drawing, a square enclosed by dashed lines represents a pixel. As shown in FIG. 12, pixels present in three pixels' worth of width are specified as thinning-out targets of the metallic image, and the metallic image is formed in a stripe pattern whose stripe width is two pixels' worth. At this time, pixels excluded from the thinning-out targets of the metallic image, and each pixel directly neighboring each of the pixels on the contour portion of the metallic image being excluded from the thinning-out targets of the metallic image, are specified as thinning-out target pixels of the color image. In other words, the color image is formed on each of the pixels being arranged one pixel's worth of width inside from each of the thinning-out target pixels of the metallic image. This provides a space portion between the metallic image and color image.

According to the variation, since a space portion between a metallic image and a color image is provided, metal ink dots and color ink dots are prevented from making contact with each other; consequently, bleeding, color mixing, and the like between the two kinds of ink dots can be prevented from occurring. This makes it possible to print an image with higher image quality while shortening the print time.

### Second Embodiment

In a second embodiment according to the invention, the quantity of thinning out a metallic image is changed while taking into consideration color density of a color image as a background color. For example, a color hue of a metallic image looks different between a case where the metallic image is superimposed and printed on a deep color such as blue or the like and a case where the metallic image is superimposed and printed on a light color such as yellow or the like. To rephrase, a metallic image is susceptible to a color tone value of a color image as a background. Accordingly, by changing the quantity of metal ink dots thinned out from a metallic image in accordance with color density (tone value) of a color image, the total quantity of metal ink dots ejected onto the color image is regulated so as to print a metallic image with clearer viewing.

In this embodiment, steps of the dot-thinning-out processing (104) are different from those in the first embodiment. The other steps, the print apparatus in use, and the like are the same as those in the first embodiment.

### Dot-thinning-out Processing

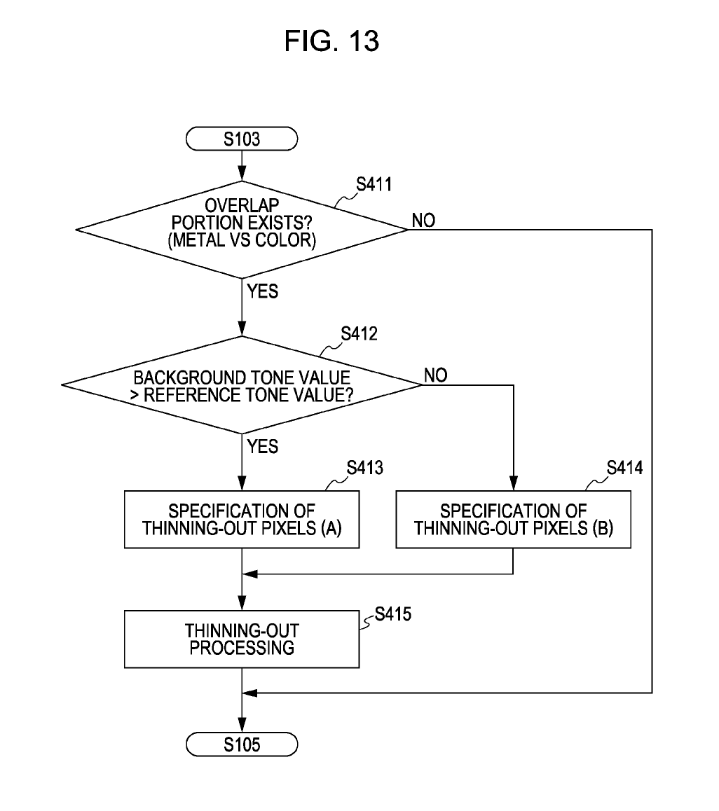

FIG. 13 is a flowchart illustrating dot-thinning-out processing according to the second embodiment of the invention. First, it is judged whether or not there exists an overlap portion of a metallic image and a color image (S411) as described in the first embodiment (S401).

If there exists an overlap portion, then a tone value of the color image as a background and a predetermined reference tone value set for each color of RGB are compared (S412). The tone value of a color image is obtained, using the color image data having experienced the resolution conversion processing, by calculating the average tone value of each color of all pixels forming the color image (hereinafter, also called a background tone value). Note that the calculation of the background tone value may be performed only on the pixels forming the overlap region in the color image.

Reference tone values have been previously determined and stored in the memory 63. They are set for each color, for example, a reference tone value of R is 160, a reference tone value of G is 192, a reference tone value of B is 128, and so on. By allowing a user to change the sizes of these reference values via the user interface after the user has confirmed an actual printed result, a metallic image with the most appropriate image quality can be obtained.

The printer driver calculates a background tone value from the image data and compares it with a reference tone value stored in the memory 63. If the background tone value is greater than the reference tone value, the process proceeds to step S413 of specification of thinning-out pixels (A) and dots are thinned out (S415). If the background tone value is equal to or less than the reference tone value, the process proceeds to step S414 of specification of thinning-out pixels (B) and dots are thinned out (S415).

In the case where the background tone value is equal to or less than the reference tone value, that is, the color of the background image is lighter, the metallic image printed on the background image is unlikely to be affected by the background image. In such case, the processing of specification of thinning-out pixels (S414) the same as the processing of specification of thinning-out pixels of the first embodiment (S402) is performed. Meanwhile, in the case where the background tone value is greater than the reference tone value, that is, the color of the background image is deeper, the metallic image printed on the background image is affected by the background image so that the color hue of the metallic image could look dark. In order to solve such problem, the rate of metal ink in the overlap region is made to be larger so as to reduce the influence of the background image. To be more specific, by lessening the number of thinning-out pixels of the metallic image so as to make a region where printing with metal ink is performed be wider, the color hue of the metallic image is prevented from being dark (S413).

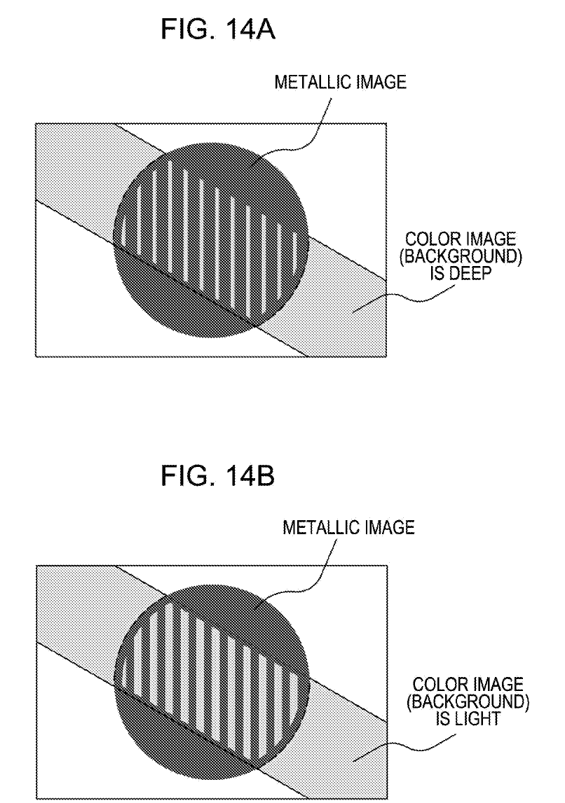

FIG. 14A is a descriptive view illustrating a state in which specification of thinning-out pixels (A) is performed (S413) when the background tone value is greater than the reference tone value; FIG. 14B is a descriptive view illustrating a state in which specification of thinning-out pixels (B) is performed (S414) when the background tone value is equal to or less than the reference tone value. In the case where the background tone value is equal to or less than the reference tone value, the image to be printed, as illustrated in FIG. 14B, is formed in a pattern in which the dots are thinned out in stripe form as explained in the first embodiment. On the other hand, in the case where the background tone value is greater than the reference tone value, the quantity of dots thinned out from the metallic image is regulated to be decreased. As a result, the quantity of metal ink dots formed for printing is increased, in comparison with the case of FIG. 14B, so that the stripe portions of the metallic image become wider as shown in FIG. 14A whereas the stripe portions of the color image become narrower. Accordingly, the rate of the metallic print portion becomes larger and the metallic image is prevented from being dark in color hue.

Further, the density of the metallic print portion can be increased by increasing the number of stripes of the metallic image, without changing the width of each stripe portion of the metallic image.

In the above example, when a background tone value is equal to or less than a reference tone value, a normal dot-thinning-out processing (the same dot-thinning-out processing as in the first embodiment) is performed in step S414. However, in step S414, the rate of thinning-out quantity of the metallic image may be changed to be larger than in the case of the first embodiment. That is to say, the region for printing with metal ink may be made narrower by increasing the number of thinning-out pixels of the metallic image.

Further, in step S412, a plurality of kinds of reference tone values may be determined in incremental steps beforehand, then the rate of thinning-out quantity of the metallic image may be changed in accordance with the size of a calculated background tone value.

### Effects of Second Embodiment

With the method according to the second embodiment, a problem such that the color hue of a metallic image is caused to change depending on the difference in color density of a color image serving as a background is solved, thereby making it possible to perform metallic printing with a stable image quality.

### Third Embodiment

A third embodiment of the invention is a print method of printing characters with metal ink. In the case where characters, particularly small characters (for example, font size is less than 16 or the like) are printed, if pixels of the character portion are thinned out, the character portion may hardly be recognized as a character, and there arises a risk that necessary information may not be transmitted. Therefore, the character portion is excluded from thinning-out targets when character information is included in a metal layer.

In the embodiment, steps of the dot-thinning-out processing (S104) are different from those in the first and second embodiments. The other steps, the print apparatus to be used, and the like are the same as those in the first and second embodiments.

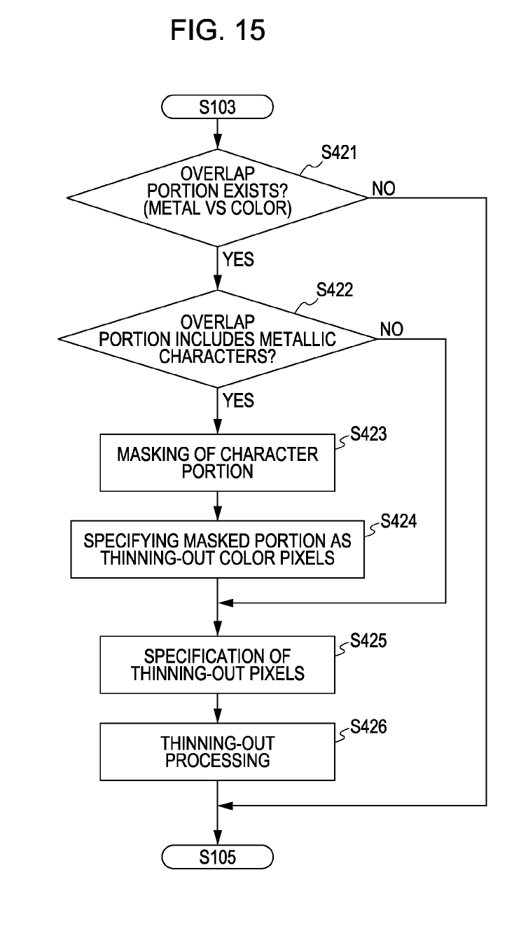

FIG. 15 is a flowchart illustrating dot-thinning-out processing according to the third embodiment. First, it is judged whether or not there exists an overlap portion of a metallic image and a color image using the same method as described in the first embodiment (S421). When an overlap portion is present, it is judged whether or not character data is included in the overlap portion (S422). When character data is included in the overlap portion, the character data is masked so that the character data is protected from being thinned out (S423); subsequently, in the overlap portion, pixels on the color image data that corresponds to the pixels configuring the masked metallic character are specified as thinning-out target pixels of color ink dots (S424). This makes it possible to suppress color ink and metal ink from being ejected on the same pixels in the character portion. Thereafter, in the same manner as in the first embodiment, processing of specification of thinning-out target pixels and thinning-out processing are performed with respect to pixels in a non-masked region (S425, S426).

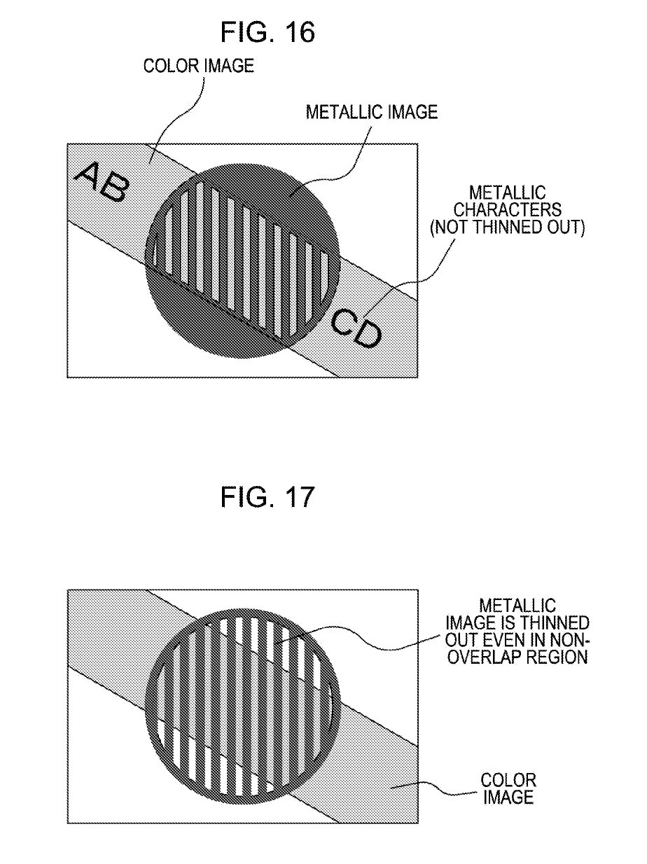

FIG. 16 shows an example of an image to be printed in the third embodiment. As shown in the drawing, in an overlap portion of a color image and a metallic image, the same dot-thinning-out processing as of the first embodiment is performed; however in an overlap portion of a metallic character and the color image, the dot-thinning-out processing is not performed and the character is printed by solid printing with metal ink.

### Effects of Third Embodiment

With the method according to the third embodiment, in the case where characters are printed with metal ink being superimposed on a color image, the characters can be printed clearly while making the print time faster than that when using the past method.

### Fourth Embodiment

In a fourth embodiment of the invention, processing to thin out metal ink dots is performed also in a portion where a metallic image and a color image do not overlap each other.

In the aforementioned embodiments, the dot-thinning-out processing is performed only in an overlap region of a metallic image and a color image. However, by performing the dot-thinning-out processing also in a region where the images do not overlap each other, the quantity of costly metal ink consumption can be reduced.

In this embodiment, steps of the processing of specification of thinning-out pixels (S402) in the dot-thinning-out processing (S104) are different from those in the first embodiment. The other steps, the print apparatus to be used, and the like are the same as in the first embodiment.

In the specification of thinning-out pixels (S402) in this embodiment, pixels other than those in an overlap region of a metallic image and a color image are treated as thinning-out target pixels among the pixels configuring the metallic image. FIG. 17 shows an example of an image to be printed in this embodiment. In an overlap region of a metallic image and a color image shown in the drawing, the dot-thinning-out processing is performed to form a stripe pattern in the same manner as explained in FIG. 8A of the first embodiment.

Further, in this embodiment, processing of thinning out dots in stripe form is performed also in a non-overlap region across the entire metallic image. With this, formed is a stripe pattern configured of the metallic image and a medium (medium ground color) in the non-overlap region of the metallic image and color image. It is to be noted that metal ink used in this embodiment contains silver particles as mentioned before. As spherical silver particles are likely to reflect light evenly, it is possible to gain a sufficient metal gloss even if the ink is not ejected across the entire print surface. That is to say, even if the image is printed in stripe form as shown in FIG. 17 without performing solid printing with metal ink, image quality (metal gloss) of the metallic image is not considerably deteriorated.

According to this embodiment, it is possible to reduce the ejection quantity of metal ink and cut down print costs while avoiding noticeable decrease in print speed and print image quality.

### Other Embodiments

A printer or the like has been described as an embodiment. However, the embodiments mentioned so far are intended to facilitate understanding of the invention, and the invention is not construed to limit the invention. Needless to say, the invention can be changed or improved without departing from the spirit and scope of the invention, and any products equivalent to those in the invention are included in the invention. In particular, such embodiments that are described below are also included in the invention.

### Record Apparatuses

In the aforementioned embodiments, although an ink jet printer is described as an example of a record apparatus that forms an image, the invention is not limited thereto. For example, the same technology described in the aforementioned embodiments may be applied to various liquid ejecting apparatuses adopting ink jet technology, such as a color filter manufacturing apparatus, a printing apparatus, a micro-fabrication apparatus, a semiconductor manufacturing apparatus, a surface treatment apparatus, a three-dimensional molding machine, a liquid vaporization apparatus, an organic EL manufacturing apparatus (a polymer molecule EL manufacturing apparatus, in particular), a display manufacturing apparatus, film formation equipment, a DNA chip manufacturing apparatus, and so on.

### Inks Used for Printing

In the aforementioned embodiments, although an example of a case where recording is performed using the ink of four colors of KCMY as color ink is described, the invention is not limited thereto. For example, colors other than KCMY, such as light cyan, light magenta, white, clear and the like may be used for printing.

Furthermore, although an example of an ink as metal ink containing silver particles, aluminum particles or the like is described in the aforementioned embodiments, ink that contains other particles such as copper, gold or the like can be used as long as a metal gloss can be gained sufficiently in the printing.

### Color Density of Color Ink

In the second embodiment, influence of the color density of metal ink at the time when printing in metal ink and printing in color ink are performed in a superimposing manner has been explained. However, elements that have such influence are not limited to the color density of color ink. It is desirable that the most appropriate method of thinning out metal ink dots is decided to be used while taking into consideration of elements that may have influence on visibility, such as ink dot size, color difference between metal ink and color ink, a medium type, color of the medium and the like, for example.

### Piezo Elements

In the aforementioned embodiments, although the piezo element PZT is exemplified as an element that performs operation to eject liquid, other elements can be exemplified. For example, a heating element, an electrostatic actuator or the like may be used.

### Printer Driver

The operation of the printer driver may be performed on the printer side. In this case, a print apparatus is configured by the printer and the PC in which the driver is installed.

### Other Apparatuses

Although the printer 1 of a type in which the head 41 is moved together with a carriage is exemplified in the descriptions of the aforementioned embodiments, the printer may be a so-called line printer in which the head is fixedly attached.

What is claimed is:

1. A print apparatus comprising:
a color ink ejecting portion that ejects color ink and a metal ink ejecting portion that ejects metal ink,
wherein the print apparatus prints an image using both color print data that is created based on color image data indicating a color image and specifies pixels to which the color ink is ejected and pixels to which the color ink is not ejected, and metallic print data that is created based on metallic image data indicating a metallic image and specifies pixels to which the metal ink is ejected and pixels to which the metallic ink is not ejected, and
wherein in the case where there exists an overlap portion of the color image and the metallic image, the pixels to which the color ink is ejected in the color print data and the pixels to which the metal ink is ejected in the metallic print data do not overlap each other.

2. The print apparatus according to claim 1,
wherein the metallic print data is created by thinning out the data of predetermined pixels among the pixels that configure the metallic image in the metallic image data, and the color print data is created by thinning out the data of pixels other than the pixels which correspond to the predetermined pixels among the pixels that configure the color image in the color image data.

3. The print apparatus according to claim 1,
wherein the metal ink is ejected to pixels on an edge portion of the metallic image in the overlap portion of the color image and metallic image.

4. The print apparatus according to claim 1,
wherein a pixel to which neither the metal ink nor the color ink is ejected is present between a pixel to which the metal ink is ejected and a pixel to which the color ink is ejected in the overlap portion.

5. The print apparatus according to claim 1,
wherein in the case where an average of tone values of the pixels configuring the color image is greater than a predetermined reference tone value, the metal ink ejected to the overlap portion becomes larger in quantity.

6. The print apparatus according to claim 1,
wherein in the case where there exists data of characters to be printed with the metal ink in the overlap portion, the metal ink is ejected to pixels configuring the characters, and the color ink is not ejected thereto.

7. A print apparatus comprising:
a color ink ejecting portion that ejects color ink and a metal ink ejecting portion that ejects metal ink containing metal particles,
wherein the print apparatus prints an image by forming color ink dots on a medium through ejecting the color ink from the color ejecting portion based on color image data indicating a color image, and forming metallic ink dots on the medium through ejecting the metal ink from the metal ink ejecting portion based on metallic image data indicating a metallic image, and
wherein in the case where there exists an overlap portion of the color image and the metallic image, the color ink dots and the metal ink dots do not overlap each other.

8. A print method comprising:
ejecting color ink from a color ink ejecting portion and also ejecting metal ink containing metal particles from a metal ink ejecting portion;
creating color print data that specifies pixels to which the color ink is ejected and pixels to which the color ink is not ejected based on color image data indicating a color image and also creating metallic print data that specifies pixels to which the metal ink is ejected and pixels to which the metal ink is not ejected based on metallic image data indicating a metallic image; and
preventing the pixels to which the color ink is ejected in the color print data and the pixels to which the metallic ink is ejected in the metallic print data from overlapping each other in the case where there exists an overlap portion of the color image and the metallic image.
